(19) United States
(12) Patent Application Publication
(10) Pub. No.: US 2006/0254420 A1
(43) Pub. Date: Nov. 16, 2006

(54) Method for prepurifying air in an accelerated tsa cycle

(76) Inventors: Christian Monereau, Paris (FR); Celina Hemeryck, Rotterdam (NL)

Correspondence Address: AIR LIQUIDE, 2700 POST OAK BOULEVARD, SUITE 1800, HOUSTON, TX, 77056, US

(21) Appl. No.: 10/560,054

(22) PCT Filed: Jun. 18, 2004
(86) PCT No.: PCT/FR04/50283

§ 371 Date: May 16, 2006

(30) Foreign Application Priority Data
Jun. 27, 2003 (FR) 03/07794

(51) Int. Cl. B01D 53/02

(52) U.S. Cl. 95/96

(57) ABSTRACT

The invention relates to a method for prepurifying air by means of adsorption, using two adsorption recipients operating alternately, in parallel, and in a TSA cycle, each recipient containing an adsorbent arranged on a radial adsorption bed, and each adsorption cycle consisting of (a) an adsorption stage during which the impurities are eliminated on the adsorbent at an adsorption temperature (rads), the air crossing the adsorption bed in a centripetal manner; (b) a regeneration stage during which the adsorbent is regenerated by flushing with a regeneration gas at a regeneration temperature (Treg), such as Treg>Tads, in order to desorb the impurities; et (c) an adsorbent cooling stage during which the temperature of the regenerated adsorbent is reduced. The maximum duration (rads) of the adsorption is 120 minutes, preferably between 60 and 120 minutes. The regeneration gas is introduced in such a way that it flushes the bed containing the adsorbent in the centrifugal direction. The maximum regeneration rate is 35% of the adsorption rate. The regeneration temperature is reached by means of a heat exchanger arrange outside the adsorber.

The present invention relates to a TSA method for prepurifying air to be fractionated subsequently by a cryogenic method.

Conventionally, the air to be distilled by a cryogenic method is previously dried, decarbonated, and at least partially stripped of the secondary atmospheric pollutants that it contains, such as hydrocarbons, nitrogen oxides or similar, by passing the air through one or more adsorbent masses arranged in one or more adsorption zones of an air prepurification unit.

This method is commonly called an air prepurification method or more simply, a head purification method.

The main object of this prepurification is to retain and remove the various atmospheric impurities that may be present in the gas stream, until the contents obtained are compatible with the satisfactory operation of the cryogenic unit fed with this air, irrespective of the level of performance or safety of the equipment.

In fact, in the absence of such pretreatment, these impurities are condensed and/or solidified during the cooling of the air to cryogenic temperature, possibly resulting in problems of equipment clogging, particularly of the heat exchangers, distillation columns, etc.

The main impurities to be removed include carbon dioxide and water vapor, which are always present in air and which solidify before reaching cryogenic temperatures of about −180° C. to −193° C., because water vapor begins to solidify as ice at about 0° C., and carbon dioxide crystallizes below −56° C. at its triple pressure and at about −130° C. at its partial pressure in air.

Moreover, it is also customary to at least partly remove what are called secondary impurities, such as certain hydrocarbons (CₙHₘ) saturated or not, and the nitrogen oxides (NₓO_{y}), inevitably present in the air, to avoid any dangerous concentration of these products in the cold box of the downstream cryogenic separation unit, particularly to absolutely prevent their concentration in the liquid oxygen vaporizer of this unit, up to a content such that the operating safety of the unit is no longer guaranteed without other precaution.

For this purpose, a prepurification method can use one or more adsorbent beds, located in one or more adsorbers, commonly called adsorption cylinders.

The adsorbents used to remove these impurities are in particular exchanged or nonexchanged zeolites, silica gels, activated and/or doped aluminas, or combinations or mixtures thereof.

Some adsorbents may, in addition to the active phase, contain a variable quantity of binder, used in particular to reinforce the mechanical strength of the adsorbent particle, such as its attrition resistance.

Industrial adsorbents are generally used in the form of beads, more or less spherical, ovoid or ellipsoid, or rods, such as extrudates, or more complex shapes.

The diameter of these beads (or equivalent dimension in the case of a rod) is generally between 1.5 and 4 mm and preferably between 2 and 3 mm.

Certain particles are formed from a mixture of two or more adsorbents, for example, a mixture of two or more compounds of the same type, such as a mixture of an Nax zeolite with an NaLSX or CaX zeolite, an X zeolite with an A zeolite, or formed from two or more compounds of different types, such as a mixture of a zeolite with an activated alumina.

Similarly, an adsorption bed may be formed from a single type of adsorbent or from two or more distinct adsorbents, either distributed in juxtaposed or superimposed layers, or in an intimate mixture, in variable proportions.

Furthermore, the adsorbers may, depending on each case, have a vertical or horizontal axis, or may be of the radial type, that is, the gas stream to be purified flows therein either vertically (in downflow), or horizontally (from left to right, or vice versa) or centripetally (radially toward the adsorber axis) or centrifugally (radially from the axis).

When fluids, particularly gases, flow through adsorbent masses having a free surface, it is essential to ensure that the flow velocity remains lower than the velocity that sets the particles in motion, to avoid or minimize any attrition or mechanical erosion of the adsorbent particles.

This requirement generally determines the cross section of the adsorber, that is, conventionally, its diameter.

However, this requirement no longer applies in the case of radial adsorbers in particular, or any other type of adsorber in which the adsorbent mass is maintained by specific means, such as grilles. In this case, in fact, the dimensions adopted are exclusively conditioned by the result of an economic optimization between equipment cost and energy consumption directly associated with the pressure drops across the system and, to a lesser extent, with the dead volumes.

Conventionally, the adsorbent mass is regenerated cyclically within the adsorber by heating and/or gas flushing, before being used again in an adsorption phase.

At present, two types of method are used in particular for this purpose, that is, PSA (Pressure Swing Adsorption) methods, in which most of the regeneration power is provided by a pressure variation or effect, and TSA (Temperature Swing Adsorption) methods, in which the regeneration power is provided by a temperature effect.

Less conventionally, hybrid solutions are also proposed for this purpose, particularly by document U.S. Pat. No. 5,614,000.

A TSA air prepurification cycle normally comprises the following steps:

a) air feed to an adsorber and purification of the air by adsorption of the impurities at superatmospheric pressure and at close to ambient temperature, that is, typically between 0° C. and about 40° C.,

b) depressurization of the adsorber to the pressure of the regeneration gas, generally atmospheric,

c) regeneration of the adsorbent at pressure lower than the adsorption pressure, particularly by a waste gas, typically impure nitrogen at atmospheric pressure issuing from the air separation unit or heated to above ambient temperature by means of one or more heat exchangers. The regeneration gas may also be at a pressure substantially higher than atmospheric pressure because of the upstream method, for example, due to a pressure distillation, the regeneration gas being used downstream of the regeneration, for example, recompressed. In this case, a shorter phase can be considered, during which a regeneration step is carried out by lowering the regeneration gas pressure to atmospheric pressure,

d) cooling of the adsorbent to ambient or subambient temperature, particularly by continuing to introduce therein said waste gas issuing from the air separation unit, but not heated,

e) repressurization of the adsorber with purified air issuing, for example, from another adsorber currently in a production phase or from a storage container. The nitrogen of the air is adsorbed on the adsorbent or adsorbents, causing warming of the gas present in the adsorber in the repressurization phase. The temperature rise depends on the quantity of energy liberated by the adsorption of nitrogen, hence by the quantity of nitrogen adsorbed, which itself depends on the regeneration and adsorption conditions,

f) inversion of the adsorbers. In this step, the energy present in the form of heat in the adsorber escapes with the air flow, causing a temporary rise in the temperature at the adsorber outlet (temperature peak). The amplitude and duration of this temperature peak depends on the quantity of energy stored during the repressurization phase and on the flow rate of air through the adsorber.

The prepurification unit may be preceded by an optional step of precooling of the air to be purified by means, for example, of one (or more) cold water heat exchanger(s), mechanical refrigeration units, or any other similar system.

A PSA air purification cycle comprises substantially the same steps a), b) and e), but is distinguished from a TSA method by the absence of heating of the waste gas or gases during the regeneration step (step c), and hence also the absence of step d).

Less conventionally, regeneration can be carried out at a substantially different pressure from atmospheric pressure, either higher as already mentioned (generally in the case of TSA), or lower than this pressure (generally in the case of PSA) by the use of adequate vacuum pumping means in this case.

Similarly, the waste gas may be a gas highly enriched with oxygen, in the event that the product utilized in the air separation unit is nitrogen, because in this case, oxygen is an unused waste product.

Generally, the air pretreatment devices comprise two adsorbers, operating alternately, that is, one of the adsorbers is in the production phase while the other is in the regeneration phase.

Such TSA air purification methods are described in particular in documents U.S. Pat. No. 3,738,084 and U.S. Pat. No. 6,093,379.

In a prepurification method, the cycle time is defined as the sum of the durations of the adsorption and regeneration steps.

In general, for a cycle with two adsorbers and continuous production, the adsorption time is half the cycle time.

The adsorption time in a PSA cycle is about 3 to 30 minutes, while in a TSA cycle, it is about 2 to 8 hours.

The volume of adsorbent used in a PSA cycle is generally lower than in a TSA cycle because the effect of the reduction of the cycle, that is, the lower quantity of impurities to be retained per phase, prevails over the fact that the regeneration of the adsorbent is only partial, which is equivalent to a lower impurity retention capacity.

Furthermore, PSA requires neither heater nor cooler, because regeneration takes place by flushing at ambient temperature.

However, the drawback of the PSA method is that the regeneration requires a high gas flow rate. Thus, as a first approximation, it can be estimated that the volume of gas needed to flush the bed to completely desorb the impurities must correspond to n times the volume of gas treated in the adsorption phase. The value of n is about 1.15 to 1.35 to take account of the various deviations from ideality.

Thus, if air with a flow rate of 100 Sm³/h at 5 bar absolute is purified for 10 minutes, in order to regenerate the adsorbent in 7 minutes (and 3 minutes for depressurization and recompression), at 1.25 bar abs, a flow rate of about 1 00×1.25/5×10/7×1.25=45 Sm³/h, or 45% of the air flow rate, is needed.

Under more favorable conditions, for example, a higher adsorption pressure, this ratio can be decreased, but for the most common air separation units, the range is generally between 30 and 50%.

In the case of TSA, the desorption energy is generally provided in the form of heat transferred to the adsorbent by the previously heated regeneration gas.

The quantity of gas required is then substantially lower, by about 5 to 25% of the flow rate of gas to be treated depending on the temperature level adopted and the cycle particulars.

It may be observed that the choice between PSA and TSA is generally based on the quantity of regeneration gas available.

Accordingly, air separation units for producing a high percentage of upgraded products, that is, oxygen, medium-pressure and low-pressure nitrogen, etc., will have very little waste gas, typically impure low-pressure nitrogen, and will therefore necessarily be provided with a TSA type head purification.

Conversely, units for producing a monoproduct, such as oxygen or medium-pressure nitrogen, will generally have sufficient waste gas to use a PSA system.

In the case of TSA units, recent developments have essentially consisted in aiming to reduce the cost of the unit (adsorber technologies, choice of adsorbent, etc.), or to minimize the regeneration flow rate to be able to produce even more pure products in the cold box of the cryogenic air separation unit (choice of adsorbent, etc.).

It is theoretically possible to shorten the cycle time of a TSA purification and, consequently, the volumes of adsorbents required, but in doing so, an increase in the regeneration gas flow rate is observed.

This increase in the regeneration gas flow rate results from the various thermal inertias of the system, independent of the cycle time and the duration of the heating and cooling steps, which are not directly proportional to the cycle time.

In fact, before beginning to effectively heat an adsorbent bed to the desired temperature level, it is important to account for the inertia and heat losses of the heater itself, the heating of the connecting pipework and the equipment it supports, that is the valves, instrumentation, etc., the heating of the end of the adsorber and, optionally, of the maintenance or filtration systems.

Since these components are dimensioned according to the flow rate of gas to be treated and/or of regeneration gas, they are constant or increase in size when the prepurification cycle time is reduced.

Similarly, for the cooling, in addition to the “adsorbent” part, it is necessary to consider the elements to be cooled upstream and downstream.

Identically, the volumes to be depressurized and then repressurized are not proportional to the volume of adsorbent, because a non-negligible, indeed preponderant part consists of “dead” volumes located in the ends of the adsorbers and in the pipework up to the shutoff valves.

In practice, for a total regeneration time of 3 hours, 2 really effective hours are available for heating the adsorbent, dissolving the impurities and cooling.

In order to have a shorter 2 hour adsorption (and regeneration) cycle, it would be necessary to approximately double the gas flow rate required.

However, in view of the above explanations, such a flow rate is generally unavailable, because otherwise, a PSA cycle would basically be selected instead of a TSA cycle.

Moreover, the percentage of effectively useful heat decreases because the metal masses pertaining to the pipework, valves, measuring and control instruments, and the end of the adsorber, remain constant, whereas the mass of adsorbents and the impurities to be desorbed decrease with the reduction of the cycle, which is equivalent to drastically increasing the energy consumption of the overall purification method.

Another drawback resulting from the increase in the regeneration gas flow rate is the increase in pressure drops, which also increases the energy consumption, unless the diameter of the adsorber is increased, thereby increasing the thermal inertia and dead volumes, etc.

It is clear so far that the potential improvement in TSA cycles directly or indirectly entails a decrease in the flow rate necessary for regeneration.

For this purpose, numerous methods have been proposed for effectively supplying heat to the beds of adsorbents.

Thus, document EP-A-766989 proposes to heat only a part of the beds of adsorbents through a partial PSA type operation.

Moreover, document EP-A-815920 describes the introduction of a heat pulse in the intermediate part of the adsorber.

Furthermore, document EP-A-884085 proposes a method involving internal heating of the adsorbent.

Also worth mentioning is document U.S. Pat. No. 4,312,641 which uses microwaves to provide the energy necessary for desorption; document U.S. Pat. No. 4,094,652 which recommends applying an electric current to electrodesorb the impurities retained by the adsorbent; and document US-A-2003/00337672 which claims the installation of the adsorbent in the tubes of the heat exchanger, thereby allowing for 2-hour cycles instead of a conventional 6-hour cycle.

In this context, the problem arising is to improve the known air prepurification methods so as to substantially reduce the TSA prepurification cycles, particularly the cycle time, and the volume of adsorbent(s) to be used, while preserving both a simple, inexpensive heating system, that is, using a standard electric or steam heater, and a regeneration flow rate compatible with the requisite production of pure products, that is, oxygen, nitrogen and/or argon.

The solution of the invention is accordingly a method for prepurifying air by adsorption using two adsorption receptacles operating in parallel, alternately and in a TSA cycle, each receptacle containing at least one adsorbent arranged in at least one adsorption bed, each adsorption cycle comprising at least:

a) an adsorption step during which at least part of the impurities present in the air is removed by adsorption on said adsorbent, at an adsorption temperature (T_{ads}), the air crossing the adsorption bed centripetally,

b) a regeneration step during which the adsorbent used in step a) is regenerated by flushing with a regeneration gas at a regeneration temperature (T_{reg}), such that T_{reg}>T_{ads}, the regeneration gas crossing the adsorption bed centrifugally, in order to desorb the impurities adsorbed in step a),

c) an adsorbent cooling step during which the temperature of the adsorbent regenerated in step b) is reduced,

characterized in that:

in step a), the adsorption time T_{ads} is between 60 and 120 minutes,
in step b), and optionally in step c), the regeneration gas is introduced into one or the other of the adsorption receptacles in order to flush centrifugally the bed containing the adsorbent used in step a), the regeneration flow rate during these steps being lower than or equal to 35% of the adsorption flow rate, and
in step b), the regeneration temperature is reached using a heat exchanger arranged outside the adsorbers.

Depending on the case, the method of the invention may comprise one or more of the following technical characteristics:
before the regeneration gas is sent to an adsorber to be regenerated in a step b), the regeneration heater used to heat the regeneration gas and all or part of the heating circuit, located between said heater and the adsorber to be regenerated, are brought to the regeneration temperature,
in step b), at least one heating parameter is controlled, selected from the group formed by the heating time, the temperature and the flow rate of the regeneration gas, so that the maximum temperature at the outlet of each adsorber is at least 30% lower than the temperature at the inlet of the adsorber concerned, preferably at least 60° C. lower, preferably at least 90° C. lower. For example, for a maximum adsorption temperature of between 50 and 70° C., for a maximum regeneration inlet temperature of 120 to 160° C.,
in step a), the adsorbent used is at least one zeolite and, preferably, at least one alumina,
in step b), the regeneration gas is nitrogen or a nitrogen-rich gas,
it comprises a step of filtration of the gas produced using a filtration means located downstream of the adsorbers,
in step b), at least one heat exchanger is used to heat the regeneration gas and at least one bypass circuit is used, arranged for bypassing the heat exchanger,
the adsorbent used is a binderless LSX type faujasite zeolite,
the regeneration flow rate is between 20 and 30% of the adsorption flow rate,
in step a), the adsorption time is between 90 and 120 minutes,
a step of cryogenic distillation or fractionation of the purified air, to produce nitrogen, oxygen and/or argon.

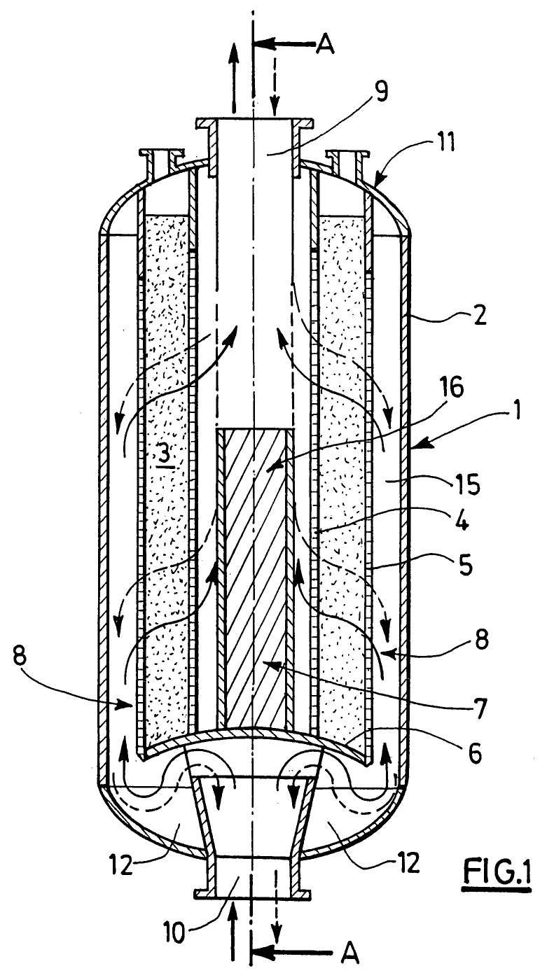

In the context of the present invention, the decrease in thermal inertia is obtained by using one or more adsorbers 1 of the radial type with centrifugal flow of the regeneration gas, that is, from the center of the adsorber 1 to the periphery, and with, by contrast, centripetal flow of the air to be purified, that is, from the periphery to the center of the adsorber 1, as shown in FIG. 1 appended hereto, which shows a cross section of an adsorber 1 with axis A-A, usable in the context of the present invention.

More precisely, the air to be purified under pressure is introduced, via a first orifice 10 located in the end 12 of the adsorber 1, on the side of the peripheral outer wall 2 of the adsorber containing the adsorbent arranged in an adsorption bed 3 of cylindrical three-dimensional shape with a hollow central volume 16, that is, the air to be purified is sent to the outer lateral periphery 8 of the bed 3 of adsorbent.

The adsorbent particles making up the bed 3 of adsorbent are maintained by two lateral grilles 4, 5 perforated with gas passage orifices, located on either side of the adsorbtion bed 3 in order to maintain the particles of said bed 3 in their initial position during the life of the equipment. Moreover, the bed 3 rests on a support structure 6 of flat, convex or other shape as required.

The air centripetally and successively crosses the grille 5, the bed 3 of adsorbent and the grille 4 to reach the center 16 of the adsorber 1.

The impurities present in the air flow at the adsorption temperature, typically between 5 and about 50° C., are adsorbed, during the adsorption phase, on the adsorption bed 3 that is formed from one or more adsorbents, preferably the bed 3 contains a layer of alumina and layer of zeolite, particularly of the faujasite type, particularly an X or LSX zeolite exchanged or not by metallic cations. The type of zeolite to be used is selected according to the impurities to be removed.

The purified air is recovered at the center 16 of the adsorber 1 and is removed to a place of storage or use, via a second orifice 9 located in the ceiling 11 of the adsorber 1.

After a given adsorption time, the adsorber 1 is regenerated by the introduction of a regeneration gas at a temperature above the adsorption temperature, for example nitrogen at a temperature of 50 to 250° C., the regeneration gas being introduced into the adsorber 1 via the second orifice 9 and crossing the bed 3 centrifugally, that is, it is introduced at the center 16 of the adsorber and then flushes the adsorption bed 3 flowing toward the outer wall 2, before being removed via the first orifice 10.

In passing through the bed 3, the regeneration gas is loaded with impurities, said impurities being desorbed from the bed 3 on which they have been retained during the previous adsorption step.

Thanks to this type of configuration, the hot regeneration gas is no longer in contact with the wall 2 of the outer envelope of each adsorber 1, which is designed to withstand the pressure mechanically, and the internal metal mass upstream of the bed or beds 3 of adsorbents can be reduced substantially.

To proceed further, the size of an internal filter 7 located at the center of the adsorber 1 is reduced by using, for example, a filter 7 with a height substantially half of that of the beds 3 without a tapered distribution portion, or this filter 7 can be moved outside the adsorber 1, that is, by placing it downstream of the prepurification unit so that it is not arranged, inside the adsorber, on the regeneration circuit.

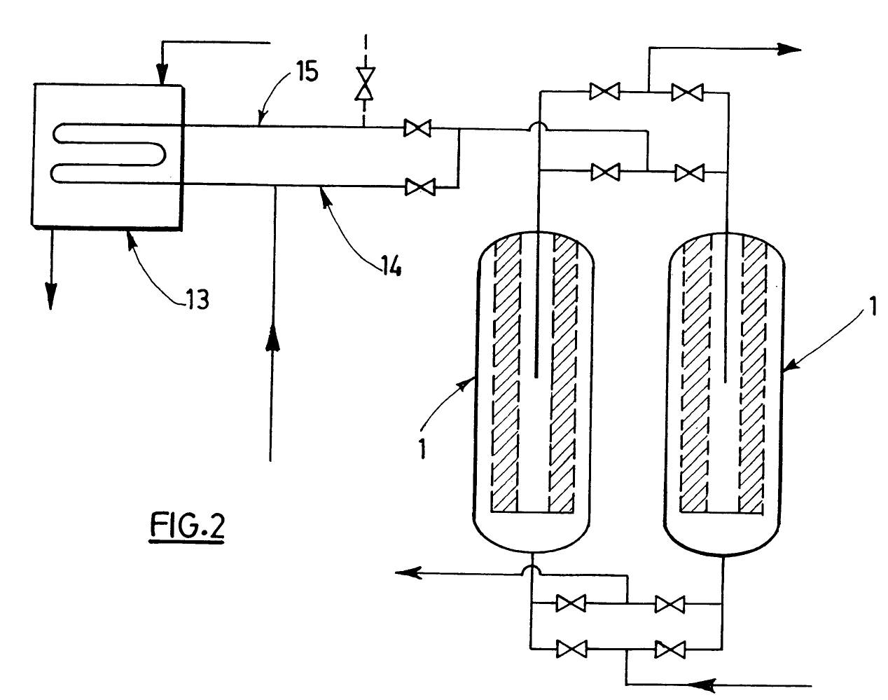

Alternatively, as shown in FIG. 2, to reduce the thermal inertia, a bypass 14 can be installed around the heater 13, irrespective of whether the latter is of the steam, electric or other type.

Thus, it becomes possible to go very rapidly from the heating phase (for regeneration) to the cooling phase (for adsorption) with temperature variations of the square-wave type.

Similarly, the heating circuit 15 can be kept hot, for example, by leaving the steam inlet open or, more generally, by maintaining the heating means, irrespective of type, at an adequate level, and optionally, by creating a small flow of fluid through this heater 13 and the connection to the adsorbers 1.

At the outlet side of the bed 3 of each adsorber 1, it is important to avoid heating the outer wall 2 more than necessary because this means, on the one hand, that the heating time has been too long and, on the other, that the cooling will also be longer than necessary.

For this purpose, an energy control system should be installed in order to adjust the heating to the strict minimum. For example, it is possible to consider the thermal profile at the outlet of the heat front to correct the estimation made on the basis of the operating conditions, as explained in document EP-A-1080773. Thus, the maximum outlet temperature obtained may be substantially lower than the regeneration temperature at the adsorber inlet. This difference depends on the adsorption and regeneration conditions (i.e. temperature and pressure), but is generally at least 20° to 30° C.

Another advantage of using a radial bed, in this case, is that the heat losses are reduced to the minimum because the heat front flowing from the interior to the exterior is not in contact with the outer walls during the heating of the adsorbent.

The cooling must also be limited in comparison with conventional cooling times, especially since the adsorber is equipped with an internal insulation device, which reduces the possibility of heat losses by useless heating of the metal of the structure, particularly the walls, of the adsorber.

In particular, during the adsorption step, the heat of adsorption of water significantly raises the temperature of the air (temperature variation of 10° C., for example), implying that the CO₂ is not adsorbed at the air inlet temperature but at that corresponding to this temperature increased by the effect of the heat of adsorption of water.

Since the heat front moves faster than the material fronts, it can be shown that it suffices to cool the beds to a temperature equal to or even higher than this sum of temperatures to obtain identical performance. In fact, the final cooling takes place by means of the gas to be treated itself.

The continual improvement in adsorbents also serves to decrease the heat capacity of the bed for a given quantity of adsorbed impurities. Adsorbents specifically developed for this type of purification are therefore preferably used. When the duration of the adsorption step is reduced, the mass transfer zone, that is, the adsorbent mass in which there is no equilibrium between the gas phase and adsorbed phase concentrations, assumes growing importance, and the volume of this mass transfer zone can then be decreased by using adsorbents of a lower equivalent diameter.

In fact, since the limitation of the kinetics is essentially due to diffusion in the macropores, a reduction in size is accompanied by an increase in the kinetics, favoring phase equilibria.

Since the square of the diameter of each adsorbent particle is a factor in determining the adsorption kinetics, an even slight reduction in diameter causes a significantly improvement in the kinetics.

Thus, it is generally useless to descend to diameters lower than 1 to 1.5 mm even for fast cycle TSA, as described in this document.

The intrinsic kinetics of certain adsorbents has increased thanks to recent developments on these products, and this is particularly true of the products called binderless X zeolites, for which, at equivalent particle size distribution, the kinetics has been found to be better in the binderless form than in the older form with binder.

In this case, no decrease in diameter is necessary to preserve good performance with shortened cycles.

As stated above, the choice of the bead size, the adsorbent geometry, etc., is part of the normal work of optimization of the unit, and takes account of both investment and energy.

Reducing the regeneration flow rate and hence the cycle time also entails an optimization of the depressurization and repressurization steps.

The regeneration flow rate may not be constant during the regeneration period. For example, the flow rate may be higher during the cooling phase than during the heating phase. This serves to decrease the heater power at a given heater outlet temperature or at constant installed capacity to obtain a higher outlet temperature. This flow rate reduction may also only occur at the end of heating to pass a higher heat peak through the adsorbent and thereby obtain better regeneration quality. This temperature peak can be pushed through the adsorbent with a high regeneration gas flow rate, the one corresponding to the cooling phase.

To shorten these steps to the minimum without creating problems of attrition or erosion, on the one hand, and without disturbing the operation of the cold box on the other, by cyclic withdrawals of purified air, valves are used with an opening and/or closing ramp and, on the cold box side of the cryogenic distillation unit located downstream, an advanced control system adjusting the various liquid and gas storage units to eliminate or at least smooth out the flow rate disturbances is used.

Thus, contrary to common practice, the method of the present invention serves to obtain TSA cycles of 240 minutes or shorter, that is, with an adsorption phase of 120 minutes or shorter, while only requiring regeneration flow rates lower than 35%, or even 30% of the air flow rate, which does not permit the use of a PSA type cycle for the same application.

### COMPARATIVE EXAMPLE

A comparison was made between a conventional TSA cycle with superposed beds, at current thermal inertias and inversion times, that is, from about 30 minutes for the longest cycles to 15 minutes for the short cycles, and an accelerated cycle TSA unit according to the invention, following the principle of FIGS. 1 and 2.

In absolute value, the regeneration flow rates indicated as a percentage of the air flow rate to be purified, for the various cases considered, obviously depend on the operating conditions, the internal design criteria specific to each installation concerned, the technologies used, the insulation quality, the layout, the type of heater, etc., but the very mechanism of the comparison remains generally applicable and serves to account for the various effects.

The TSA cycle is an air purification cycle for which the adsorption step is carried out at 6 bar abs and 25° C.

Table I below gives the regeneration flow rate, expressed as a % of the air flow rate, for various adsorption times.

TABLE I

| | | Regeneration flow |
|---|---|---|
| | Adsorption time | rate (% of air |
| Test No. | (in minutes) | flow rate) |
| A | 180 | 30 |
| B | 120 | 35 |
| C | 60 | 55 |

As table I shows, the significant increase in the gas flow rate (nitrogen for example) necessary for regeneration reflects the preponderance of the thermal inertia and dead time when the cycle time is shortened, because to reduce the cycle type from 180 minutes to 60 minutes implies an approximate doubling of the regeneration flow rate.

In fact, for such high flow rates, it becomes advantageous to use a PSA cycle rather than a TSA cycle, but with the attendant drawbacks, as explained above.

Based on test C in table I, a test D was performed using a radial adsorber and total bypass of the heater, as recommended in the context of the present invention.

Similarly, based on this test D, a test E was performed, by further introducing a 30% shortening of the transitory steps, essentially the depressurization step (high flow rate made possible by the radial solution), an advanced control system of the type described in document EP-A-1080773 and improved cooling, that is, limited to a temperature due to the adsorption of water.

The results of tests D and E are given in table II below; test C is given for comparison.

TABLE II

| | | Regeneration flow |
|---|---|---|
| | Adsorption (in | rate (% of air |
| Test No. | minutes) | flow rate) |
| C | 60 | 55 |
| D | 60 | 42 |
| E | 60 | 33 |

It may be observed that in this way, we return to a necessary regeneration rate like the one corresponding to cycles that are 2 to 3 times longer (tests A and B of table I), for an adsorption time of only 60 minutes, therefore 2 to 3 times shorter than that of tests A and B.

As mentioned above, these flow rates depend on the operating conditions and would be lower in case of a lower adsorption temperature or higher pressure, for example, if the air were to contain less water to be desorbed.

The use of a higher regeneration temperature also serves to decrease the necessary regeneration flow rate.

The method of the invention thus proves advantageous on “short” or “very short” cycles, that is, those of 120 minutes to 60 minutes, respectively, but it must be pointed out that it may also be advantageous for longer cycles, particularly up to 180 minutes or more, because it allows the regeneration flow rate to be reduced and a maximum quantity of purified air to be produced.

The “radial” adsorber technology, that is, with an bed of adsorbent arranged in the form of a three-dimensional cylinder, allows for considerable dimensioning flexibility because, on the one hand, it avoids the maximum velocity requirements, which allows the cross sections offered to the flowing gases in circulation to be reduced, and, on the other, it also allows the installation of high cross sections associated with thin beds if it is desired to preferably reduce pressure drops and hence energy consumption.

By way of example, two dimensioning examples of “radial” TSA units according to the invention for purifying a high air flow rate, that is, a flow rate of 860 000 Sm³/h at a pressure of 7.5 bar abs and a temperature of 21° C., are given in Table 3 below.

The short cycle regeneration flow rate represents about 30% of this flow rate, or 1.05 bar abs at the TSA unit outlet for a regeneration temperature of 150° C.

Depending on the local cost of energy, it could be possible, for example, to adopt one or the other of the following dimensions.

TABLE III

| | Example 1 | Example 2 |
|---|---|---|
| [L] Diameter (m) | 5.5 | 5.3 |
| Outer grille diameter (m) | 4.6 | 4.4 |
| Inner grille diameter (m) | 2.6 | 2.7 |
| Height (m) | 11.6 | 13.7 |

However, even with conventional adsorbers, with superposed beds, the implementation of certain aspects of the method of the invention, such as the prior heating to the regeneration temperature of the heater and the regeneration circuit, serves to decrease the regeneration flow rate, and hence the cycle time for a given available regeneration flow rate.

However, in this case, the beds of adsorbent are necessarily thin and, for high flow rates of air to be purified, that is, of about at least 100 000 Sm³/h, the adsorbers will be difficult to industrialize and will have large dead volumes, i.e. they will be adsorbers of the “cheese box” type. In this case, it would be better to use spherical adsorbers or preferably, cylindrical adsorbers with a horizontal axis.

1-10. (canceled)

11. A method for prepurifying air by adsorption using two adsorption receptacles operating in parallel, alternately and in a TSA cycle, each receptacle containing at least one adsorbent arranged in at least one adsorption bed, each adsorption cycle comprising at least:
a) an adsorption step during which at least part of the impurities present in the air is removed by adsorption on said adsorbent, at an adsorption temperature (T_{ads}), the air crossing the adsorption bed centripetally,
b) a regeneration step during which the adsorbent used in step a) is regenerated by flushing with a regeneration gas at a regeneration temperature (T_{reg}), such that T_{reg}>T_{ads}, the regeneration gas crossing the adsorption bed centrifugally, in order to desorb the impurities adsorbed in step a),
c) an adsorbent cooling step during which the temperature of the adsorbent regenerated in step b) is reduced,
wherein:
i) in step a), the adsorption time (T_{ads}) is between 60 and 120 minutes,
ii) in step b), and optionally in step c), the regeneration gas is introduced into one or the other of the adsorption receptacles in order to flush centrifugally the bed containing the adsorbent used in step a), the regeneration flow rate during these steps being lower than or equal to 35% of the adsorption flow rate, and
iii) in step b), the regeneration temperature is reached using a heat exchanger arranged outside the adsorbers.

12. The method of claim 10, wherein, before the regeneration gas is sent to an adsorber to be regenerated in a step b), the regeneration heater used to heat the regeneration gas and all or part of the heating circuit, located between said heater and the adsorber to be regenerated, are brought to the regeneration temperature.

13. The method of claim 10, wherein in step b), at least one heating parameter is controlled, selected from the group formed by the heating time, the temperature and the flow rate of the regeneration gas, so that the maximum temperature at the outlet of each adsorber is at least 30% lower than the temperature at the inlet of the adsorber concerned, preferably at least 60° C. lower.

14. The method of claim 10, wherein in step a), the adsorbent used is at least one zeolite and, preferably, at least one alumina.

15. The method of claim 10, wherein in step b), the regeneration gas is nitrogen or a nitrogen-rich gas.

16. The method of claim 10, wherein it comprises a step of filtration of the gas produced using a filtration means located downstream of the adsorbers.

17. The method of claim 10, wherein in step b), at least one heat exchanger is used to heat the regeneration gas and at least one bypass circuit is used, arranged for bypassing the heat exchanger.

18. The method of claim 10, wherein the adsorbent used is a binderless LSX type faujasite zeolite.

19. The method of claim 10, wherein the regeneration flow rate is between 20 and 30% of the adsorption flow rate and/or in step a) the adsorption time (T_{ads}) is between 90 and 120 minutes.

20. The method of claim 10, wherein it further comprises a step of cryogenic distillation or fractionation of the purified air, to produce nitrogen, oxygen and/or argon.
